(19) United States
(12) Patent Application Publication
(10) Pub. No.: US 2008/0105618 A1
(43) Pub. Date: May 8, 2008

(54) METHOD AND APPARATUS FOR THE REMOVAL OF HARMFUL CONTAMINANTS FROM PORTABLE DRINKING WATER DEVICES

(75) Inventors: Robert Beckius, Placitas, NM (US); Tim Oriard, Issaquah, WA (US); Paul Smith, Kirkland, WA (US)

Correspondence Address: LAW OFFICES OF RONALD M ANDERSON, 600 108TH AVE, NE, SUITE 507, BELLEVUE, WA, 98004, US

(73) Assignee: MesoSystems Technology, Inc., Albuquerque, NM (US)

(21) Appl. No.: 11/927,440

(22) Filed: Oct. 29, 2007

Related U.S. Application Data
(60) Provisional application No. 60/855,067, filed on Oct. 27, 2006.

(51) Int. Cl. B01D 61/16; B01D 61/18

(52) U.S. Cl. 210/650; 210/500.21; 210/500.23; 210/500.25

(57) ABSTRACT

A portable water filter including a plurality of different filter medias. One embodiment includes two filter exhibiting a synergistic effect on filtration. Another embodiment provides higher than normal pH water to simply removal; of dissolved metals. Still another embodiments meets specified performance parameters. The filters are usable in hand held water purifiers, gravity feed filtration systems, and personal hydration systems. The water filter is lightweight to facilitate being carried in the field by a person for extended periods.

### RELATED APPLICATIONS

This application is based on a prior copending provisional application Ser. No. 60/855,067, filed on Oct. 27, 2006, the benefit of the filing date of which is hereby claimed under 35 U.S.C. § 119(e).

### BACKGROUND

Uncontrolled water supplies are readily contaminated with bacteria, viruses, and protozoa (prominent examples of which are Giardia lamblia and Cryptosporidium parvum). These contaminants are common causes of diarrheal disease in man. Of the many pathogenic coliform bacteria, adenoviruses, and enteric viruses, Escherichia coli (or “E. coli”) is considered to be the general indicator of water contamination by fecal material. Most waterborne diseases are related to fecal pollution of water sources and the presence of these pathogens indicates the immediate and urgent need for the removal of undesired and potentially pathogenic microorganisms prior to human consumption.

Microorganism filtration methods are currently being developed for the removal of viruses, bacteria, and protozoa, including C. parvum and Giardia. However, most of these methods, especially those targeting viruses, lack sufficient water production rates or require unrealistic energy burdens.

Many large-scale treatment facilities that meet the purification standards of the Environmental Protection Agency (EPA) exist. Unfortunately, these technologies (such as distillation or ultraviolet exposure) are complex and unrealistically large to expect a reduction in scale necessary to meet the needs of an individual soldier in the field. Filtration and chemical treatment technologies for individual water purification also exist but suffer limitations on a pathogen-specific basis. For example, chemical treatment using common oxidants (such as chlorine and hydrogen peroxide) has proven highly effective against viruses but virtually useless against protozoan cysts, such as C. parvum. The converse is true for commercially available water filters; they can remove Cryptosporidium with little difficulty, yet fail to meet EPA removal standards for viruses and some bacteria.

What is needed is a light-weight, modular, and easily transportable way of rendering surface water potable in useful quantities without an undue energy burden.

### SUMMARY

Disclosed herein are a plurality of concepts (method and apparatus) for filtering ambient water to provide potable drinking water.

A first aspect of the concepts disclosed herein is method and apparatus for combining two different filter medias so as to achieve a synergistic effect. A first of the two filter medias is a filter media that exhibits a surface charge that enables natural organic matter to be filtered based on surface charge interactions. In general, most naturally occurring organic matter exhibits a negative surface charge. Therefore, the first filter media exhibits a positive surface charge (even where the net charge for the first filter media is neutral). Magnesium oxide represents an exemplary first filter media. Significantly, viral contaminants exhibit negative surface charges, thus, such a filter media can remove viral contaminants from water. A second exemplary filter media is a disinfectant, which increases the efficacy of the filtering by enhancing a rate at which viral contaminants are deactivated. For example, while the first filter media may remove viral contaminants, the first filter media may not neutralize (i.e., kill) the viral contaminants very rapidly, meaning there is a chance that the viral contaminants may be dislodged and re-enter the water. Halogens attached to inert substrates represent exemplary disinfectants. Alone, the first filter media can remove viral contaminants, and alone, a disinfectant can kill viral contaminants. Empirical studies performed in developing this technology have indicated that when used together, a synergistic effect is achieved (that is, the two materials are more efficient used together than one would expect based on their individual effectiveness). Synergist effects of greater than 10% have been noted.

Thus, one aspect of the concepts disclosed herein is a method of filtering water using both a first filter media configured to remove natural organic matter using surface charge interactions, and a second filter media having disinfectant qualities, where there is a synergistic effect between the first and second filter medias when used in combination. Similarly, one aspect of the concepts disclosed herein is a water filter including both a first filter media configured to remove natural organic matter using surface charge interactions, and a second filter media having disinfectant qualities, where there is a synergistic effect between the first and second filter medias.

Significantly, the synergistic effect noted above enables a highly efficient portable water filter to be achieved. In the prior art, to achieve water filtration for removing viral and other contaminants, tradeoffs existed between size and efficiency. For example, high quality filtration could be achieved using relatively large filters including relatively large volumes of filter media. Small, portable filters could be achieved, but such filters generally had to sacrifice some level of efficiency to achieve a small filter. For example, ultra small pore membranes can provide quality filtration, but generally require a large pressure differential to drive water through the small pores, and the small pores can become loaded with contaminants relatively quickly (i.e., after filtering a relatively small volume of water). To achieve a portable filter suitable for providing potable drinking water for an individual, the prior art has focused on using carbon based filters, often with an additional filter media, to remove many chemical contaminants and bacteria. While such filters are useful, they are not as effective as is desired with respect to removing viral contaminants and dissolved metals. The synergistic technology noted above enables higher quality filtration to be provided in a reduced form factor filter.

Another aspect of the concepts disclosed herein is directed to technology (method and apparatus) for providing potable water with a higher than normal pH (i.e., a pH of greater than 9). Conventional drinking water standards for municipal water utilities require water to be provided to end users with a pH ranging from about 5.5 to about 8.5. While such standards are readily achievable for municipalities, achieving quality filtration and an end product with a pH ranging from about 5.5 to about 8.5 using a portable filtering technology under field conditions can be problematical. Applicants have recognized that under certain circumstances, it is more important to provide safe drinking water, albeit at a relatively high pH (water having a relatively high pH can taste bitter), than it is to provide aesthetically pleasing water. Dissolved metals can be more readily removed from water by precipitation at relatively higher pHs. Portable water purification can be greatly simplified by sacrificing the steps of reducing the pH after metals have been removed. Thus, one aspect of the concepts disclosed herein is providing a portable water filter (and method) where the pH is raised to a relatively high level (i.e., a level higher than normally associated with drinking water, such as over 9).

Still another aspect of the concepts disclosed herein is a portable water filter massing less than about 250 grams, exhibiting a pressure drop ranging from about 0.5 psi to about 5.0 psi, and being capable of providing potable water at a flow rate ranging from about 50 ml/min to about 5000 ml/min, using only gravity as a motive force, where the filter removes viral contaminants in additional to bacteria, particulates, and chemical contaminants. In general, the prior art has had to sacrifice removal of viral contaminants to achieve a filter with similar characteristics. Such a filter can be implemented using four types of filter media, including a membrane based media for removing particulates via mechanical filtration, a carbon media for removing contaminants via adsorption, a filter media for removing organic matter via surface charge interactions, and a disinfectant filter media.

In at least one exemplary embodiment, a water filter described herein is formed as a modular component to be inserted into a commercially available hydration system (for example, the CAMELBAK® hydration system). The device is inserted in-line with the hydration system drink tube via quick release fittings. The device contains a disposable cartridge insert that has a service life expectancy of up to 750 liters of filtered water. Such a water filter removes viruses using a filter media that interacts with surface charges carried by the virus, rather than by using a filter media having pore sizes smaller than the virus (note that such extremely small pore sizes increase the pressure drop exhibited by the filter).

One aspect of a filter according to embodiments described herein is that it is lightweight, having a nominal total mass of less than 250 grams. Exemplary filters massing about 190 grams have been successfully implemented.

Another aspect of a filter according to one or more of the embodiments described herein is that it has a form factor sufficiently small to be hand held, approximately the size of a small flashlight.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 graphically illustrates a synergistic effect on filtration efficiency noted when two filter media defined herein are used in combination;

FIG. 2 illustrates a perspective view of a filter according to a first exemplary embodiment of portable filters disclosed herein;

FIG. 3 illustrates a section view of a filter according to the first exemplary embodiment of FIG. 2;

FIG. 4 illustrates a schematic view of a filter according to a second exemplary embodiment of the concepts disclosed herein; and

FIG. 5 schematically illustrates the use of a holding volume to further increase filtration efficiency.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

As noted above, the concepts disclosed herein encompass water filters for providing potable drinking water and method of filtering water to provide potable drinking water. Significantly, the concepts disclosed herein can be used to achieve a portable water filter that can be used in conjunction with personal hydration systems. One broad aspect of the techniques disclosed herein relates to a novel combination of a first filter media and a second filter media, wherein the combination of filter media achieves a synergistic effect on filtration. A second broad aspect of the techniques disclosed herein relates to providing potable drinking water with a relatively higher pH than is generally considered acceptable. While such relatively high pH water is less aesthetically pleasing than conventional drinking water, such relatively high pH water is safe for human consumption, and such relatively high pH water can be provided using relatively small man portable water filters. A third broad aspect of the techniques disclosed herein relates to compact portable water filter that can provide potable drinking water using only gravity as a motive force, where the portable water filter can remove contaminants including bacteria, chemicals, metals, and viruses. Such a filter masses less than about 250 g, and is capable of providing a minimum flow rate of about 50 ml/min. Significantly, similarly compact prior art filters have generally been incapable of removing viral contaminants without utilizing ultra-small pore membranes, which significantly reduce achievable flow rates where gravity is providing the motive force.

Synergistic Filtration

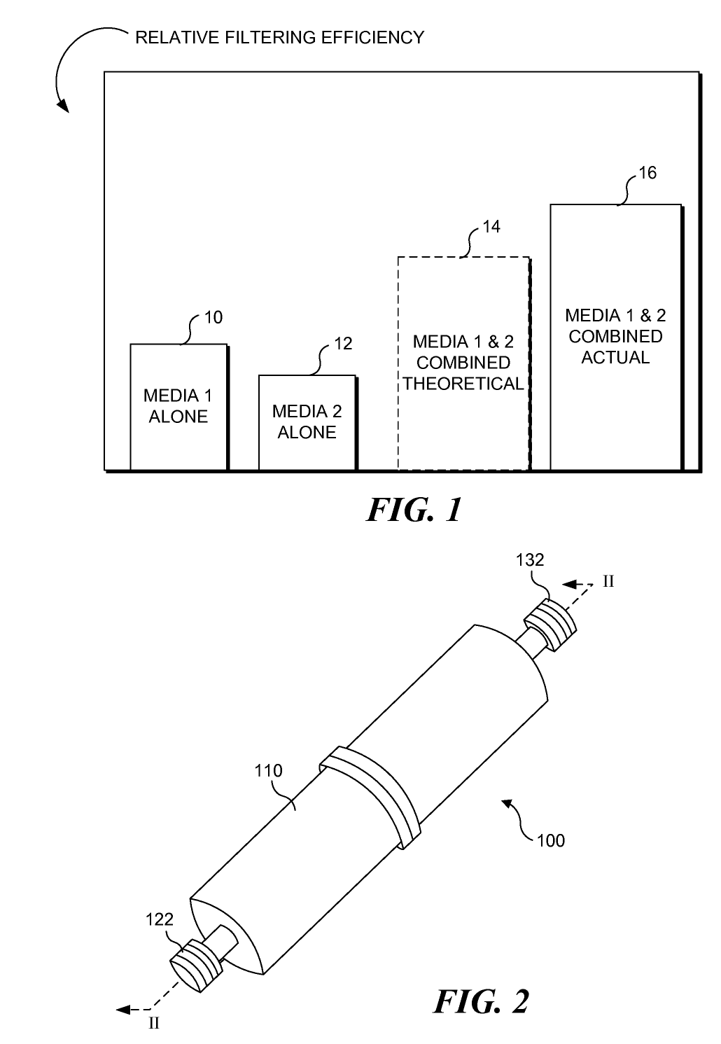

Referring now to the first aspect of the concepts disclosed herein, applicants have identified two different filter medias, which when combined provide a synergistic effect, generally as indicated in the graph of FIG. 1. A first filter media 10 and a second filter media 12 can be used individually to filter drinking water. Theoretically, when the first and second filter medias are used in combination (as indicated by a theoretical combined filter media 14), it would be expected that a relative efficiency of the combination would be equivalent to a relative efficiency of the first filter media plus the relative efficiency of the second filter media. However, in the case of the first and second filter medias identified by applicants, it has been empirically discovered that when used in combination, the first and second filter media identified by applicants provides a relatively higher filtration efficiency than would be expected (as indicated by synergistic combined filter media 16). Applicants have tested a variety of related first and second filter media, and found a synergistic effect of at least a 10% higher than expected filtration efficiency. In some cases, empirical data suggest that the synergistic effect can provide an improvement approaching 50%. It should be understood that the graph of FIG. 1 is intended to be exemplary of this identified synergistic effect, rather than representing specific values. Indeed, many empirical studies have indicated synergistic effect exceeds 10%. Actual details from one of these studies is provided below in Table A.

The first filter media identified by applicants is characterized by having a positive surface charge. Most natural organic matter, including viral contaminants, exhibit negative surface charges. Filter media exhibiting a positive surface charge can remove such natural organic matter and viral contaminants from water via surface charge interactions. An exemplary first filter media is magnesium oxide. It should be recognized however, that other filter media having a positive surface charge may also be suitable for use as a first filter media. A potential problem with using a first filter media by itself is that there is a possibility that some of the retained natural organic matter, particularly viral contaminants, may at some point in the filtration process become dislodged from the first filter media. Where the first filter media exhibits relatively strong disinfectant properties, viral contaminants that are attained on the first filter media for relatively short periods of times will likely be successfully deactivated (i.e., killed). However, the less effective the first filter media is with respect to being a disinfectant, the more likely it is that a viral particle retained on the first filter media will become dislodged and reintroduced into the water being filtered, before the virus particle is deactivated.

It should also be understood that the disinfectant properties of the first filter media will vary based on the type of filter media having a positive surface charge that is implemented. As noted above, magnesium oxide represents an exemplary first filter media. Magnesium oxide is available in several different grades. Some grades are more effective than other grades at raising the relative pH of the water being filtered. Viral disinfection by the magnesium oxide itself is generally more successful at higher pHs. Thus, the different grades of magnesium oxide will exhibit different disinfectant properties. If a different first filter media having positive surface charges is employed, that filter media will likely exhibit distinguishable disinfectant properties.

The second filter media identified by applicants, which when used in combination with the first filter media will provide a synergistic effect, is a filter media exhibiting relatively stronger disinfectant properties (i.e., a filter media that is a better disinfectant than the first filter media exhibiting the desired surface charge properties noted above). It appears that by employing a relatively strong disinfectant along with a filter medium that can immobilize viruses using surface charge effects improves filtration by increasing an amount of the immobilized viruses that can be deactivated in a relatively short period of time. This is significant, because it enables a relatively small amount of filter media to successfully deactivate viral contaminants in a relatively large volume of water, enabling a high-quality portable water filter to be achieved. This becomes especially true when working with very small filters with limited space for working media, and short fluid contact times when higher flow rates are desired.

Halogens bound to an inert substrate represent an exemplary second filter media. While free halogens, such as chlorine tablets, would provide a disinfectant, such a filter media would undesirably introduce an excess of halogens into the water being filtered. That is, more chlorine would be introduced into the water being filtered than would be used to deactivate the viral contaminants and organic matter in the water. This would present an additional filtration challenge, in that another layer of filter media would be required to remove the excess chlorine. Where halogens are bound to an inert substrate, the halogens are available to be used to deactivate organic matter, while being generally retained upon their inert substrate, and thus excess halogens are generally not introduced in large quantity into the water being filtered. Therefore, an additional filter layer to remove the excess halogens is not required. Halogen impregnated media is readily available (an example of which is HaloPure by HaloSource). The substrate media is generally a polymeric media which functions as a matrix for housing a reservoir of halogen that is not readily soluble in the influent water. However, when a microbe encounters the media surface, a halogen molecule is released from the polymer matrix and is absorbed by the microbe, resulting in destruction of the microbe.

Thus, the first filter media (the filter media characterized as having positive surface charges) removes viral contaminants from water, and the second filter media (characterized as having relatively strong disinfectant properties) increases the efficacy of the filtering by enhancing a rate at which viral contaminants are deactivated. Alone, the first filter media can remove viral contaminants, and alone, a disinfectant can kill viral contaminants. As noted above, empirical studies performed in developing this technology have indicated that when used together, a synergistic effect is achieved (that is, the two materials are more efficient used together than one would expect based on their individual effectiveness). Synergistic effects of greater than 10% have been noted.

Referring once again to the novel concepts disclosed herein, a filter media that removes viruses from water due to the interaction between surface charges on the virus (as opposed to a pore size smaller than the virus), is combined with at least one other filter media, to enable a variety of different contaminants to be removed from water.

It should be noted that some microbes are less easily susceptible to halogen disinfection (an example is type 2 Polio virus), thus, the magnesium oxide may deactivate materials that cannot be deactivated by the halogen aided filter media (i.e., the second filter media exhibiting relatively stronger disinfectant properties). Furthermore, some microbes are less susceptible to pH influence or electro-static capture (an example is the FR bacteriophage virus), thus, the disinfectant filter media is available to deactivate those types of microbes. By combining both filter media (i.e., the first filter media exhibiting charge surface interactions, and the second filter media exhibiting relatively stronger disinfectant properties) in a multi barrier approach, a broader spectrum of disinfection can occur than with either filter media alone.

Significantly, the synergistic effect based on combining a filter media exhibiting charge attraction properties and a filter media exhibiting disinfection properties was unexpected. It should be noted that while magnesium oxide is intended to represent an exemplary first filter media exhibiting desirable surface charge properties (meaning that other filter media exhibiting a positive surface charge could be combined with a disinfectant filter media to achieve a similar synergistic effect), the use of magnesium oxide provides additional beneficial effects, beyond the synergistic effect noted above. For example, magnesium oxide filter media is multi functional, as in addition to removing natural organic matter due to surface charge interactions, the magnesium oxide enhances metals removal by increasing the relative pH of the water being filtered (thus favoring precipitation of dissolved metals as metal hydroxides). Furthermore, it is believed that magnesium oxide represents a particularly useful first filter media due to its relatively high isoelectric point.

Magnesium oxide has an isoelectric point just over pH 11, which means for incoming water having a pH below that, the surface of the magnesium oxide will have a positive surface charge. Viruses (and bacteria) also have an isoelectric point, such that below their isoelectric point they exhibit a positive surface charge and above their isoelectric point they exhibit a negative surface charge. That point is different for different organisms. Because magnesium oxide has such an unusually high pH isoelectric point, most recognized pathogenic micro-organisms assume a negative surface charge under the influence of magnesium oxide. The negative surface charge on the microbe and the positive surface charge on the magnesium oxide cause electro-static type attraction and bonding. Further, because of the high pH environment right at the magnesium oxide surface, it is likely (but not completely proven) that the microbes are eventually killed (probably over the course of minutes or hours), unlike many other electro-static bonding materials. The fact that magnesium oxide itself exhibits some disinfectant properties is beneficial because, as noted above, some microbes are less easily susceptible to halogen disinfection (an example is type 2 Polio virus).

Magnesium oxide represents a particularly efficient first filter media (i.e., a filter media exhibiting desirable surface charge properties) where a portable and relatively small water filter is desired. Because of the short contact times and relative high flow rates required for such portable water filters, it is desirable for the filter medias employed in such a portable filter to perform “double duty” whenever possible. Where magnesium oxide is present in such a portable water filter, the magnesium oxide can increase the pH of relatively low pH influent water (such as acid rain influenced water sources or high organic (humic and tannic) acid containing influent water) by neutralizing the acids (due to magnesium oxide's basic properties). Magnesium oxide can also facilitate removal of dissolved metals. Many metals that are dissolved in solution, particularly the cationic metals, often form hydroxide precipitates at various pHs, depending on the particular metal in question. When these dissolved cationic metals in solution encounter the relatively high pH magnesium oxide surface, many will form metal hydroxides that precipitate out of solution onto the magnesium oxide surface.

The natural organic matter removal capabilities of magnesium oxide can greatly enhance the efficacy of the halogen matrix, because by reducing the amount of organic background in solution, the magnesium oxide also reduces the chemical background demand of the solution, thereby freeing up more of the halogen to disinfect microbes, instead of reacting with background organic matter. This effect also can help reduce the possible formation of tri-halo-methanes and other disinfection byproducts that may otherwise form without the magnesium oxide treatment step.

As noted above, many different grades of magnesium oxide are available. Furthermore, many different grades of halogen impregnated filter media are also available. Halogenated filter media can be obtained where the halogen comprises chlorine, bromine, or iodine. While the synergistic effect discussed above will be exhibited by combinations of these different materials, it should also be recognized that the filtering effect can be modified using careful selection of the first filter media (i.e., the filter media exhibiting the desirable surface charge properties) and second filter media (i.e., the filter media exhibiting the relatively stronger disinfectant properties). For example, if it is recognized that the water being filtered is likely to be a relatively low pH, then in the first filter media can be selected based on its ability to moderate pH (for example, some grades of magnesium oxide are able to moderate lower pH levels than other grades of magnesium oxide; and other potential first filter medias may be less able to moderate low pH levels). Thus, the ability to moderate pH may be a factor in selecting a particular first filter media. The ability to moderate the pH of the water being filtered is significant beyond simply correcting undesirably low pH levels in the water. As discussed above, a relatively higher pH can lead to relatively better metal filtration. Furthermore, the pH within the filter may also have an effect on the efficiency of the disinfectant. For example, where the disinfectant filter media is a halogenated impregnated filter media, relatively greater amounts of halogens will become available to the water being filtered as the pH within the filter is increased. Thus, if it is recognized that the water to be filtered it may be relatively more contaminated with microbes and viral contaminants than might be considered normal, it may be desirable to select a first filter media that will increase a relative pH within the filter, to ensure that relatively larger amounts of halogens are available to the water being filtered. It should be recognized that this will have the effect of exhausting the halogenated impregnated filter media at a higher rate, meaning that less water can be safely filtered given the same volume of halogenated filter media. Thus, in circumstances where the viral and microbe contamination will be relatively lower, it will be less desirable to increase the relative pH of the water within the filter, to avoid prematurely exhausting the halogenated filter media. In at least some embodiments, the first filter media and the second filter media will be mixed together, which will have the effect of increasing a relative pH proximate the halogenated filter media, thereby making more of the halogens available to the water being filtered.

Thus, even where the synergistic effect between the first filter media and the second filter media is exploited, careful selection of the first filter media and second filter media actually implemented can provide measurable differences in filtration.

As noted above, Table A provides details of one of the empirical studies, which indicates that the synergistic effect can exceed a 20% increase in filtration efficiency. The first filter media (i.e., the filter media exhibiting desirable surface charge properties) employed was magnesium oxide, and the second filter media (i.e., the filter media exhibiting a greater disinfectant properties) employed was a chlorinated filter media (HaloPure) provided by HaloSource. Both of the filter medias were tested alone, and then in combination. These tests were performed using de-ionized lab water seeded with the MS2 virus. The data has been equalized for volume of media, flow rate of water, and media/water contact time. Parameters for each test included 5.0 cubic inches of filter media, 200 ml/min flow rate, and 9.6 seconds of contact time between the relative filter media and the influent water.

TABLE A

| | Virus | Virus | Log | Percent |
|---|---|---|---|---|
| | Influent | Effluent | Virus | Virus |
| Media Type | (pfu/mL) | (pfu/mL) | Removal | Removal |
| Magnesium Oxide | 8.10 × 10⁴ | 1.65 × 10⁴ | 0.69 | 79.7 |
| granules | | | | |
| Chlorine impregnated | 1.80 × 10⁴ | 4.43 × 10³ | 0.61 | 75.4 |
| resin | | | | |
| MgO & Chlorine resin | 3.80 × 10⁴ | 1.64 × 10² | 2.36 | 99.6 |
| (50%-50%) mix | | | | |

Note that based on a 50/50 mixture of the filter medias, one would have calculated the removal efficiency of the mixture to be about 77.55 (one half of 79.7 plus one half of 75.4)

Portable Filter Providing Relatively High pH Drinking Water

As noted above, another aspect of the concepts disclosed herein is a portable apparatus (i.e., a water filter) directed to providing potable drinking water having a relatively higher pH than is normally associated with drinking water. Conventional drinking water ranges from about 5.5 to about 8.5 pH (based on guidelines for a municipal water utilities in the United States). Applicants have realized that these standards are based on aesthetics, rather than being based on providing water that is fit for human consumption. Applicants have further realized that there exist ambient waters containing relatively large amounts of dissolved metals which must be filtered to provide potable water. Providing a quality portable water filter to remove relatively large amounts of dissolved metals is problematical, because conventional filtration techniques would require relatively large amounts of filter media to first increase the relative pH of the water and precipitate out the dissolved metals, and then to decrease the relative pH of the water to provide filtered water ranging from about 5.5 to about 8.5 pH. Applicants have realized that eliminating the additional filter media required to decrease the relative pH of the water after the dissolved metals have been precipitated enables relatively high pH potable water to be achieved using a compact and relatively small water filter. While the relatively high pH potable water provided by such a technique does not meet normal aesthetic quality standards for drinking water, it does provide potable drinking water, and in certain circumstances, a relatively larger quantity of un-aesthetically pleasing but potable drinking water is preferable to relatively smaller quantities of aesthetically pleasing drinking water.

It should be recognized that the phrase relatively high pH potable water is intended to encompass water that is fit for human consumption and in excess of a pH of about 9. Such drinking water can be obtained by filtering ambient water using a portable water filter including a sufficient quantity of magnesium oxide to increase a pH of the ambient water to greater than about 9. Such a portable water filter will be particularly beneficial in providing potable drinking water from ambient waters containing relatively large amounts of dissolved metals. Of course, where portability of the filter is not required, larger filters including additional layers could be used to provide a more aesthetically pleasing drinking water.

Various embodiments of such a portable water filter are envisioned. In at least one embodiment, such a portable water filter includes a filter media configured to remove particulates using mechanical filtration, and a filter media configured to remove contaminants via absorption, in addition to the magnesium oxide filter media. If desired, the halogenated filter media discussed above can also be employed in such a portable water filter, to provide the synergistic effects noted above.

Portable Filter Meeting Specified Parameters

Yet another aspect of the concepts disclosed herein is a portable water filter that meets specified parameters that have been unable to be achieved using conventional filtration technology. Such a portable filter is relatively small, relatively light weight, can remove a range of the contaminants including viral contamination, and provides a flow rate sufficient to provide drinking water for an individual without requiring any motive force other than gravity. The specified parameters include a mass of less than about 250 g, a minimum flow rate of about 50 ml (optionally a maximum flow rate of about 5000 ml per minute) where the force of gravity is used to drive water through the portable water filter, and a pressure drop ranging from about 0.5 psi to about 5.0 psi.

While portable water filters massing less than about 250 g are known in the art, conventional portable water filters are generally either are not well-suited to remove viruses, or cannot meet the specified flow rates and pressure drops because they incorporate a filter member exhibiting a pore size smaller than the average size of a virus to provide adequate removal of viral contaminants.

In an exemplary embodiment, such a portable water filter can be implemented using the following filter media: 1) a membrane filter configured to remove relatively larger particles via mechanical filtration; 2) a carbon based filter media for removing contaminants via absorption; 3) a magnesium oxide based filter media to remove natural organic matter and viral contaminants via service charge interactions; and 4) a disinfectant filter media configured to enhance deactivation of viral contaminants and microbes.

It should be recognized that the following embodiments may be described in connection with a single one of the aspects discussed above, however, the following embodiments can be used to implement any of the three broad aspects of the concepts disclosed herein.

Specific Portable Filter Embodiments

Referring to FIG. 2, a perspective view of a filter according to a first exemplary embodiment of the concepts disclosed herein is illustrated. A filter 100 has a housing 110 that is generally elongated in the direction of flow of water from an inlet coupling 122 to an output coupling 132. It should be recognized that various types of coupling can be implemented, including but not limited to male couplings, female couplings, and threaded couplings. Where the filter is used as an inline filter for a personal hydration system, the coupling can advantageously share a coupling form factor already employed in the hydration system.

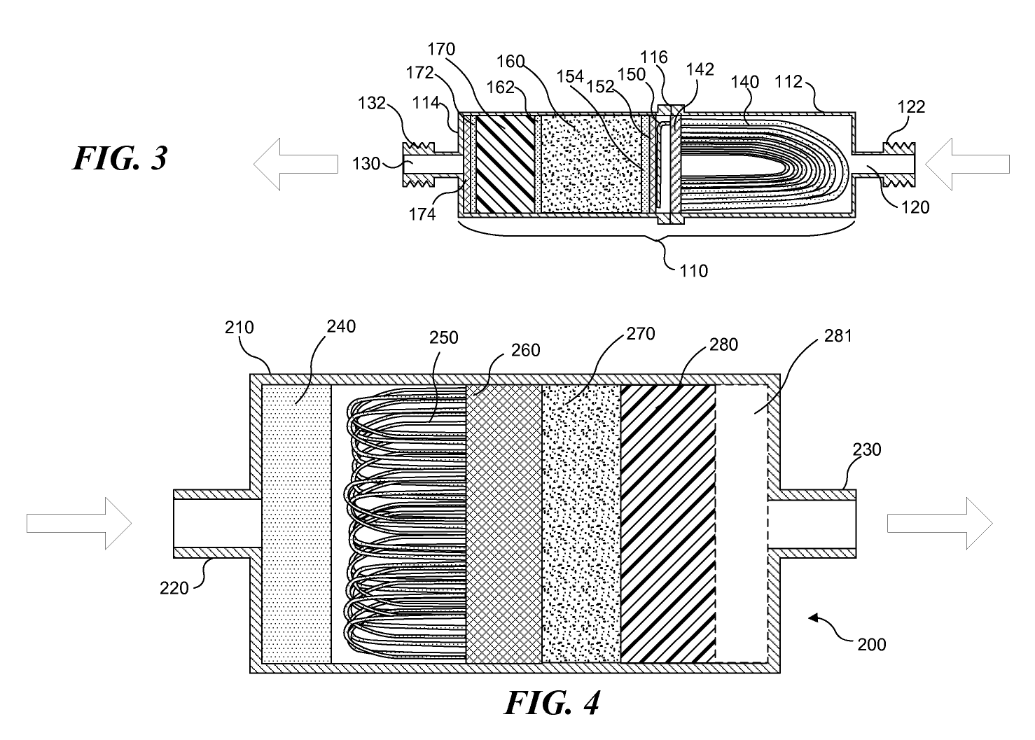

Referring to FIG. 3, a section view (taken along section line II-II in FIG. 2) of filter 100 is illustrated. An inlet passage 120 extends axially from one end of elongated housing 110 and terminates at inlet coupling 122. An outlet passage 130 similarly extends axially from the other end of elongated housing 110 and terminates at outlet coupling 132. Water flows into the filter via the inlet passage, through the inside of housing 110, and out via the outlet passage. The housing is advantageously formed by combining an inlet side housing shell 112 and an outlet side housing shell 114, which are fixed together at a circumferential joint 116. It should be recognized that such a configuration is exemplary, rather than limiting. For example, a clam shell type housing can be employed, where the clamshell joint extends either latitudinally or longitudinally.

A filter according to the exemplary embodiment of FIGS. 2 and 3 includes three different filter technologies: hollow fiber membranes, activated carbon, and a synergistic combined filter media that removes viruses and naturally occurring organic matter via surface charge interactions, and deactivates the organic matter/viruses via disinfectant action. Thus, the synergistic combined filter media includes the first filter media (i.e., a filter media exhibiting desired surface charge properties) and a second filter media (i.e., a filter media exhibiting relatively stronger disinfectant properties) discussed in detail above. As noted above, the two different filter medias exhibiting a synergistic effect on filtration can be implemented as individual homogeneous layers, or as a single layer where the two different filter medias have been mixed together.

As water flows into housing 110, it first encounters hollow fibers 140, which serve as a membranous filter element. The water molecules migrate from the outside surface of the hollow fibers to the hollow interior, and then outward through the hollow ends of the fibers. A seal 142 is provided at the open ends of hollow fibers 140. Upon emerging from the hollow open ends of hollow fibers 140, the water then flows in sequence through a layer of granulated activated carbon 160, and combined synergistic filter media 170.

Permeable media separators 154, 162, and 172 are disposed at each end of granular activated carbon layer 160 and exchange resin layer 170, to retain the filter media layers in their relative positions within housing 110. It should be recognized however, that mixtures of filter media can be employed in place of well defined layers. A media tension spring 150 is disposed between seal 142 and a screen 152 to apply compressive force against media separator 154, to facilitate retention of filter media layers 160 and in their relative positions within the housing 110. After passing through all filter media and the last media separator, the water flows through an outlet screen 174 and out of housing 110 via outlet passage 130.

Couplings 122 and 132 are shown as being male threaded couplings; however, other types of coupling, such as Hydrolink-type couplings, can be employed. Thus, any coupling scheme may be used to insert the filter into a drinking water line. Hydrolink couplings are commonly used in the CAMELBAK® hydration systems.

With respect to joint 116 between inlet side housing shell 112 and outlet side housing shell 114, such a joint can be configured in various ways. If it is desired for the filter to be disassembled and refilled with a fresh cartridge in the field, then joint 116 is embodied with a twist lock feature to securely, yet releasably, engage housing shells 112 and 114 with one another. On the other hand, to prevent tampering with the filters in the field, joint 116 may be permanently joined using cement, welding, or other more permanent fixation means, so that the unit can only be reloaded with a new cartridge at a manufacturer facility. Either housing configuration may be desirable depending upon security conditions in the field. Other means of joining the inlet side and outlet side housing shells together may also be used, such as threaded parts, clamps, and other ways known in the art.

It should be recognized that filter media 170 can be implemented simply by magnesium oxide, in embodiments implementing a portable water filter configured to provide relatively high pH potable drinking water, generally as discussed above.

Referring to FIG. 4, a schematic view of a filter according to a second exemplary embodiment is illustrated. Although the form factor may vary, the second embodiment has in common with the first that it is a representation of an in-line post filter for use in a personal hydration system. Water flows into a filter 200 via an inlet passage 220, and sequentially through five media layers 240, 250, 260, 270, and 280, which are retained inside a housing 210, before exiting through an outlet passage 230.

First media layer 240 is a coarse depth-filter of polypropylene felt or foam. The function of first layer 240 is to remove visible debris and detritus, algal filaments and large silt particles by mechanical sieving action.

Second media layer 250 is a bundle of 0.2 micron hollow fiber membranes. The function of second layer 250 is to remove algae, protozoa, bacteria and general turbidity through size exclusion.

Third media layer 260 is granular magnesium oxide having a high surface area and high surface activity. The function of third layer 260 is to remove viruses, humic and other organic acids, and many heavy metals through surface charge attractions and active surface chemistries. A high surface area is considered to be greater than about 50 m²/g, and a high surface activity is considered to be an activity index of less than about 8 seconds.

Fourth media layer 270 is granular activated carbon. The function of fourth layer 270 is to remove a large array of dissolved organic carbon compounds, including chemical warfare agents, as well as toxic industrial chemicals, via chemical absorption.

Fifth media layer 280 is a halogenated filter media. The function of fifth layer 280 is to provide a disinfectant functionality, and to enhance the effectiveness of the filter via the synergistic effect discussed above in detail.

An optional holding volume 281 can be included if desired. The purpose of the holding volume is discussed in detail below. It should be noted that such a holding volume can be part of the filter itself, or can be implemented as a separate volume downstream of the filter outlet.

No media separators, media tension spring, or screens are shown in FIG. 4, nor is a joint for the housing shown. These features may be added to the second embodiment in a like manner to their implementation as shown for the first embodiment, in order to gain the operational benefits they provide. However, it should be recognized that such features are not strictly necessary in order to practice the technology disclosed herein.

In studying empirical data from for the synergistic embodiment in particular, it has been recognized that the filtration effectiveness with respect to deactivating viral contaminants and microbes can be improved simply by providing a residence time chamber or holding volume. Generally as described above, a relatively small amount of the halogen will become disassociated from the halogenated filter media, and will be introduced into the water being filtered. Design of the filter will take into account how many halogen atoms will be released into the water being filtered, to ensure that the amount of halogens in the filtered water does not exceed safe limits for potable drinking water. The function of the residence time chamber or holding volume is to provide additional time for the free halogens in the water being filtered to deactivate the viral contaminants and microbes in the water that have not been retained by the magnesium oxide filter media. The design of the filter is to provide a safe drinking water that is 99.6% free (see Table A above) of viral pathogens, based on drawing water through the filter by gravity and drinking the water immediately after exits the filter. If the water is held in some reservoir for a period of time before drinking, the halogens remaining in the water will continue to deactivate microbes and viral contaminants. Empirical data has indicated that holding periods ranging from about one to about five minutes will reduce viral contamination levels to below detection limits. The size of the holding volume will be a function of how the portable water filter will be used.

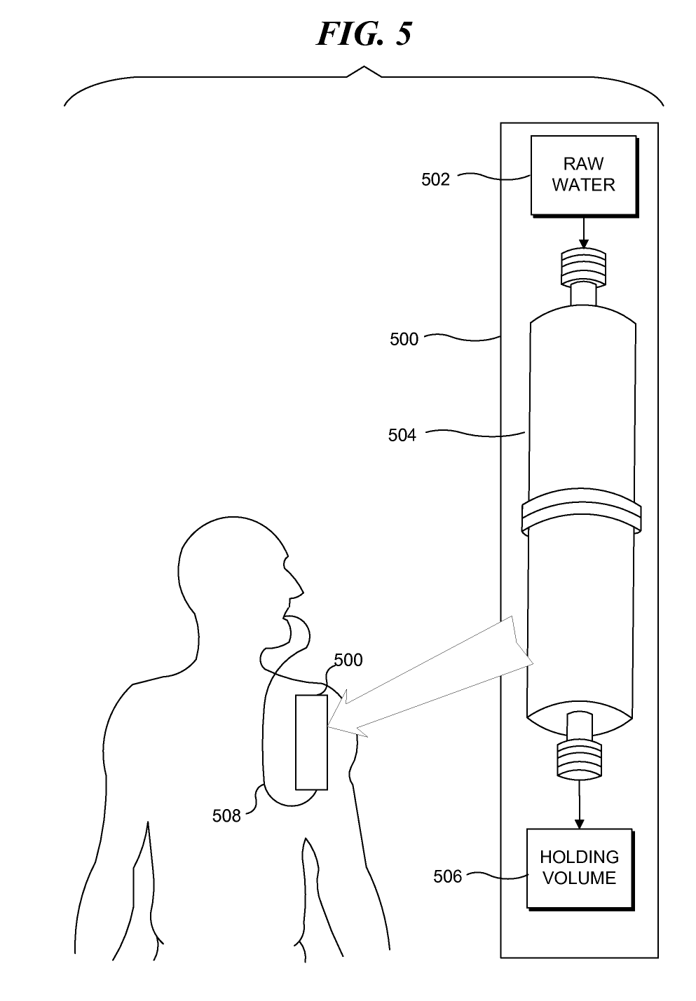

FIG. 5 schematically illustrates a personal hydration system 500, including a raw water reservoir 502, an in-line filter 504 (generally as described above), and a holding volume 506. Tubing 508 is provided to enable a user to draw water out of personal hydration system 500.

It should be recognized that the size of the holding volume is entirely a function of how much filtered water should be immediately available to the user. For example, if the portable water filter will only be required to provide one or two mouthfuls of water over any five-minute period, and the holding volume can be relatively small (i.e., approximately the size of 1-2 mouthfuls of water). If it is expected that relatively larger amounts of water will be required, a relatively larger holding volume can be provided. For example, personal hydration systems generally include a tank worn over a user' back that contains anywhere from about 1 to about 3 L of water. One use of the portable filters disclosed herein is as an in-line filter for such personal hydration systems, where the portable filter is disposed in between the water reservoir and the user's mouth. It would be simple to incorporate a holding volume in between the filter outlet and a user's mouth, ranging anywhere from several milliliters to hundreds of milliliters in size. Furthermore, depending on an amount of time available for filtering, unfiltered water could be stored in a first personal hydration system, which could be coupled to a second personal hydration system via portable filters such as those described above. Over a period of time, the downstream personal hydration system would become filled with water filtered once through the portable filter. Residual halogens within that second personal hydration system would continue to reduce the amount of viral contaminants and microbes.

With respect to the various filter embodiments discussed above, it should be recognized that the ordering of layers shown in the first and second embodiments is not strictly required to practice embodiments of the technology disclosed herein. The filter may be alternatively implemented with the layers of filter media in a different order (recognizing that in some embodiments it is desirable for the two filter media which achieve a synergistic effect to be disposed in close proximity, or even intermingled into a single layer). Further exemplary water filters encompassed within the concepts disclosed herein are presented below. It should be recognized that these specific embodiments are simply exemplary, and not limiting. The membrane filter is first in order in each example. However, other layers of media are arranged in different order. While overall filter volumes can vary, in at least one preferred embodiment, the filter volume is at least as large as a mouthful of water, such that when used in a personal hydration system, the filter will include a pre-filter mouthful of water.

### ADDITIONAL EXAMPLE 1

According to a first additional example, the filter is implemented with four sequential layers of filter media. The first layer is a hollow fiber membrane, which is followed in sequential order by a second layer of carbon (granular or block), a third layer of halogen impregnated beads (chlorinated or brominated), and a fourth layer of magnesium oxide.

### ADDITIONAL EXAMPLE 2

According to a second additional example, the filter is implemented with four sequential layers of filter media. The first layer is a hollow fiber membrane, which is followed in sequential order by a second layer of halogen impregnated beads (chlorinated or brominated), a third layer of carbon (granular or block), and a fourth layer of magnesium oxide.

### ADDITIONAL EXAMPLE 3

According to a third additional example, the filter is implemented with four sequential layers of filter media. The first layer is a hollow fiber membrane, which is followed in sequential order by a second layer of magnesium oxide, a third layer of halogen impregnated beads (chlorinated or brominated), and a fourth layer of carbon (granular or block).

### ADDITIONAL EXAMPLE 4

According to a fourth additional example, the filter is implemented with four sequential layers of filter media. The first layer is a hollow fiber membrane, which is followed in sequential order by a second layer of carbon (granular or block), a third layer of magnesium oxide, and a fourth layer of halogen impregnated beads (chlorinated or brominated).

### ADDITIONAL EXAMPLE 5

According to a fifth additional example, the filter is implemented with four sequential layers of filter media. The first layer is a hollow fiber membrane, which is followed in sequential order by a second layer of magnesium oxide, a third layer of carbon (granular or block), and a fourth layer of halogen impregnated beads (chlorinated or brominated).

### ADDITIONAL EXAMPLE 6

According to a sixth additional example, the filter is implemented with four sequential layers of filter media. The first layer is a hollow fiber membrane, which is followed in sequential order by a second layer of halogen impregnated beads (chlorinated or brominated), a third layer of magnesium oxide, and a fourth layer of carbon (granular or block).

If desired, an antimicrobial agent can be added to the fiber membrane layer. The fiber material can be impregnated with an antimicrobial agent, which is preferably mixed with the fiber during spinning and formation of the fibers so that it is dispersed throughout the fibers and will diffuse to the surface of the fibers during use of the filter. Such fibers typically are rendered antimicrobial, either by treating them topically or by impregnating them with the antimicrobial agent during their extrusion. Exemplary concentrations of the antimicrobial agent generally ranges from about 100 to about 10,000 ppm. Exemplary agents will be practically insoluble in the water passing through the filter, and are safe, non-toxic, non-carcinogenic, non-sensitizing to human and animal skin, and will not accumulate in the human body when ingested. An exemplary antimicrobial agent will have a broad spectrum, such that it is substantially equally effective against a majority of harmful bacteria encountered in water. For example, an antimicrobial agent such as 2,4,4′-trichloro-2′-hydroxydiphenol ether, or 5-chloro-2-phenol (2,4 dichlorophenoxy), commonly sold under the trademark MICROBAN™, by Microban Products Co., represents one exemplary, but not limiting, antimicrobial agent.

As noted above, in addition to the filter media configured to remove viruses by interacting with surface charges, some embodiments will incorporate additional filter media configured to remove additional types of contaminants.

With respect to the claims that follow, it should be recognized that any reference to claim elements in the singular, for example, using the articles “a,” “an,” or “the” is not to be construed as limiting the element to the singular.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A portable water filter for removing contaminants from water to provide potable drinking water, the portable water filter comprising:
(a) a housing having a compact form factor, the compact form factor enabling the portable water filter to be used as a man-portable device, the housing including an inlet for receiving water to be filtered, and an outlet for discharging filtered water; and
(b) a plurality of filter media disposed between the inlet and the outlet, the filter media comprising:
(i) a first filter media having a surface charge selected to retain natural organic matter and viruses based on surface charge interactions; and
(ii) a second filter media having disinfectant properties, wherein the combination of the first filter media and the second filter media achieves a synergistic effect on filtration.

2. The water filter of claim 1, wherein the second filter media comprises a halogenated filter media, the halogenated filter media exhibiting a surface chemistry that enables halogens incorporated into the halogenated filter material to react with contaminants in the water being filtered.

3. The water filter of claim 1, wherein the plurality of filter media further comprises:
(a) a fiber membrane configured to remove contaminants from the water being filtered based on mechanical filtration; and
(b) a carbon based material for removing chemical contaminants via absorption.

4. The water filter of claim 3, wherein the fiber membrane comprises a plurality of hollow fiber membranes having a porosity of about 0.2 micron.

5. The water filter of claim 1, wherein the first filter media comprises magnesium oxide.

6. The water filter of claim 1, wherein the second filter media comprises a polymeric substrate to which halogens have been attached.

7. The water filter of claim 6, where the first filter media and second filter media are mixed together in the filter, such that a proximity of the first filter media to the second filter media increases an effectiveness of the halogenated filter media.

8. The water filter of claim 1, wherein the form factor of the water filter is sufficiently small to enable the water filter to be used as an inline filter in a man-portable hydration system, and the water filter exhibits a pressure drop ranging from about 0.5 psi to about 5.0 psi, with a flow rate ranging from about 50 ml to about 5000 ml, where a motive force behind the flow rate is gravity.

9. A method for removing contaminants from water to provide potable water, the method comprising the steps of:
(a) filtering viral contaminants using a first filter media exhibiting surface charge characteristics enabling viral contaminants to be filtered via surface charge interactions; and
(b) treating contaminants using a second filter media having disinfectant properties, wherein the combination of the first filter media and the second filter media achieves a synergistic effect on filtration.

10. The method of claim 9, wherein the second filter media comprises a halogenated filter media exhibiting a surface chemistry that enables halogens incorporated into the halogenated filter material to react with contaminants in the water being filtered.

11. The method of claim 10, further comprising the step of increasing a pH of the water being filtered to at least about 9, such that:
(a) dissolved metals are removed via precipitation; and
(b) an amount of halogens available to react with contaminants in the water being filtered is increased.

12. The method of claim 11, wherein the step of increasing pH is implemented using the first filter media.

13. The method of claim 10, further comprising the step of providing a filter chamber containing a mixture of the first filter media and the halogenated filter media, such that a proximity of the first filter media to the halogenated filter media increases an effectiveness of the halogenated filter media.

14. The method of claim 9, wherein the method does not substantially impede a flow of water induced by gravity, such that a flow rate ranging from about 50 ml/min to at least about 5,000 ml/min is achieved when the method is implemented.

15. The method of claim 9, wherein the step of filtering viral contaminants using the first filter media comprises the step of using magnesium oxide as the first filter media.

16. A portable water filter for removing contaminants from water to provide potable water, the filter comprising:
(a) a housing having a compact form factor, the compact form factor enabling the water filter to be used as a man-portable device, the housing including an inlet for receiving water to be filtered, and an outlet for discharging filtered water; and
(b) a plurality of filter medias disposed between the inlet and the outlet, the filter media comprising:
(i) a quantity of a magnesium hydroxide filter media sufficient to increase a pH of water flowing through the filter to at least about 9, the magnesium hydroxide removing viruses via surface charge attractions, and heavy metals via precipitation induced by relatively high pH environment; and
(ii) a carbon based on filtration media for removing chemical contaminants.

17. The water filter of claim 16, wherein the plurality of filter medias further comprise a plurality of hollow fiber membranes having a porosity of about 0.2 microns.

18. The water filter of claim 16, further comprising a halogenated filter media, the relatively high pH environment established by the magnesium hydroxide filter media increasing an amount of halogens available to react with contaminants within the water being filtered, the halogens increasing a rate at which viruses removed by the magnesium hydroxide are deactivated, such that the magnesium hydroxide and the halogenated filter media achieve a synergistic effect.

19. The water filter of claim 16, wherein the water filter exhibits a pressure drop ranging from about 0.5 psi to about 5.0 psi, with a flow rate ranging from about 50 ml to about 5000 ml, where a motive force behind the flow rate is gravity

20. A method for removing contaminants from water to provide potable water, the method comprising the steps of:
(a) filtering the water with a quantity of magnesium oxide sufficient to increase a pH of the water being filtered to greater than about 9, the pH enhancing precipitation of dissolved metals and the magnesium oxide removing viral contaminants using surface charge interactions; and
(b) filtering the water using a carbon based filter media.

21. The method of claim 20, further comprising the step of removing particulates using a first filter media comprising a plurality of hollow fibers to filter the water.

22. The method of claim 20, further comprising the step of treating contaminants using a halogenated filter media, the halogenated filter media exhibiting a surface chemistry that enables halogens incorporated into the halogenated filter material to react with contaminants in the water being filtered, wherein the combination of the magnesium oxide filter media and the halogenated filter media achieves a synergistic effect on filtration.

23. A portable water filter for removing viruses, bacteria, particulates, metals, and chemical contaminants from water to provide potable water, the filter massing less than about 250 grams, the filter exhibiting a pressure drop ranging from about 0.5 psi to about 5.0 psi, and being capable of providing potable water at a flow rate ranging from about 50 ml to about 5000 ml using only gravity as a motive force, the filter comprising:
(a) a housing having a compact form factor, the compact form factor enabling the water filter to be used as a man-portable device, the housing including an inlet for receiving water to be filtered, and an outlet for discharging filtered water; and
(b) a plurality of filter media disposed between the inlet and the outlet, the filter media comprising:
(i) a plurality of hollow fiber membranes;
(ii) a carbon based filter media;
(iii) a first filter media configured to remove viruses using surface charge interactions; and
(iv) a second filter media configured to treat contaminants using at least one halogen.

24. The water filter of claim 23, wherein the first filter media and the second filter media are selected based on a synergistic effect provided when the first and second filter media are used together.

25. A method for removing contaminants from water to provide portable drinking water, where the contaminants include particles, chemicals, and viral contaminants, the method comprising the steps of:
(a) directing water through a filter massing less than about 250 grams, wherein water moves through the filter due to the force of gravity at a flow rate of not less than about 50 ml/min, such that while the water flows through the filter, the following steps are performed:
(i) removing particulate matter and relatively larger biological particles using a filter material having a pore size smaller than the particulate matter and the relatively larger biological particles;
(ii) removing contaminants via absorption;
(iii) removing viruses using a filter material that interacts with a surface charge of the virus; and
(iv) treating contaminants using a second halogenated filter media, the halogenated filter media exhibiting a surface chemistry that enables halogens incorporated into the halogenated filter material to react with contaminants in the water being filtered, wherein the combination of the first filter media and the second filter media achieves a synergistic effect on filtration.
